(19) United States
(12) Patent Application Publication
(10) Pub. No.: US 2004/0252512 A1
(43) Pub. Date: Dec. 16, 2004

(54) Lamp polarization converting optical system, and image display system

(75) Inventors: Akira Sekiguchi, Tokyo (JP); Tomohiro Sasagawa, Tokyo (JP); Tetsuo Sato, Tokyo (JP); Yoshiyuki Goto, Tokyo (JP); Kohei Teramoto, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/755,352

(22) Filed: Jan. 13, 2004

(30) Foreign Application Priority Data
Jul. 30, 2001 (JP) 2001-230226

(51) Int. Cl. F21V 7/00

(52) U.S. Cl. 362/341

(57) ABSTRACT

A lamp has a hybrid lamp reflector and a hybrid lamp front lens. In the reflector, an area outside of a boundary line with includes a lamp reflector having the shape of a paraboloid of revolution, and an area from the boundary line to an optical axis includes a lamp reflector having the shape of an aspherical revolution. The hybrid lamp front lens outputs light fluxes emitted from an arc discharge and reflected by the hybrid lamp reflector parallel to the optical axis.

### BACKGROUND OF THE INVENTION

1. Field of the Invention

The present invention relates to a lamp having a lamp illuminant, a lamp reflector, and a lamp front glass in which a light is reflected by the lamp reflector, and the reflected one is output through the lamp front glass, and the present invention further relates to a polarization converting optical system and an image display system using the lamp.

2. Description of the Related Art

FIG. 1 is a diagram showing a configuration of a conventional polarization converting optical system. In FIG. 1, reference number 101 designates a conventional lamp. Reference character 101a denotes a lamp illuminant for emitting arc light generated by arc discharge, 101b indicates a lamp reflector having a shape of a paraboloid of revolution, and 101c designates a lamp front glass placed at the aperture of the lamp reflector 101b. The conventional lamp 101 comprises the lamp illuminant 101a, the lamp reflector 101b, the lamp front glass 101c. Reference number 102 designates a lens array in which a plurality of lenses are arranged in array, and 103 denotes a polarizing conversion element in which a plurality of polarizing beam splitters (hereinafter referred to with “PBS”) prisms arranged in array form.

The light emitted from the lamp illuminant 101a is reflected by the lamp reflector 101b of a shape of a paraboloid of revolution and output to the area front of the lamp 101 through the lamp front glass 101c. Following this, the light is input into the lens array 102 and then focused into each lens focus of the lens array 102. At the position of each lens focus the corresponding polarizing conversion element 103 is placed. The polarized light passed through the polarizing conversion element 103 is aligned in a same direction.

FIG. 2 is a diagram showing the operation of the polarizing conversion element 103. In FIG. 2, reference character 103a designates a PBS prism forming the polarizing conversion element 103. Reference character 103b denotes an obstructer for obstructing the light, and 103c denotes a phase-difference film for converting a P polarized component in the light into a S polarized component.

The obstructer 103b and the phase-difference film 103c are mounted alternately on the incident plane and the outgoing plane of each PBS prism 103a.

As shown in FIG. 2, when a random light (P+S) including the P polarized component and the S polarized component from the lens array 102 is input into one PBS prism 103a of the polarizing conversion element 103, the P polarized component in the random light travels as a straight light through the PBS prism 103a without no polarization, but the S polarized component (designated by reference character “S”) thereof is refracted in direction which is curved with 90 deg. The curved S polarized component is then refracted again by another PBS prism 103a adjacent to the former PBS prism 103a and then output through a different position when compared with the P polarized component.

At this time, the P polarized component is converted to the S polarized component and then output through the phase-difference film 103c which is put on the PBS prism 103a. By this manner, all of the S polarized components of lights output from the polarizing conversion element 103 are converted to the S polarized component. In order to avoid any generation of excess lights the obstructer 103b is put on the incident side of the PBS prism 103 having no phase-difference film 103c. Such a polarization converting optical system is applied to a following image display system, for example.

FIG. 3 is a diagram showing a configuration of a typical optical system as a conventional image display system using a liquid crystal display (LCD) system. In FIG. 3, the same components of the configuration shown in FIG. 1 will be referred to with the same reference numbers and characters.

In FIG. 3, reference number 102 designates a primary fly-eye lens (lens array), 104 denotes a secondary fly-eye lens, 105 indicates a primary field lens, 106 indicates a mirror, 107 designates a secondary field lens, 108 denotes a primary dichroic mirror, 109 indicates a mirror, and 110 designates a secondary dichroic mirror. Each of reference characters 111R, 111G, and 111B designates a collimator lens, and 112R, 112G, and 112B denote liquid crystal display (LCD) panels for red, green, and blue, respectively.

Reference number 113 designates a primary relay lens, 114 denotes a mirror, 115 indicates a secondary relay lens, 116 designates a mirror, 117 indicates a dichroic prism, and 118 denotes a projecting lens.

A description will now be given of the operation of the conventional condensing optical system using the conventional lamp 101.

The light emitted from the lamp illuminant 101a is reflected by the lamp reflector 101b of the paraboloid of revolution, and then travels as a parallel light flux, and output to the front area of the lamp 101 through the lamp front glass 101c.

The parallel light flux from the lamp 101 is input into the primary fly-eye lens 102, then divided into a plurality of light fluxes, and focused into the polarizing conversion element 103. The light passed through the polarizing conversion element 103 is aligned in polarization and then passes through the secondary fly-eye lens 104 immediately placed closed to the polarizing conversion element 103. The secondary fly-eye lens 104 has the function to set the plane of the primary fly-eye lens 102 and each plane of the RCD panel 112R, 112G, and 112B in conjugate relationship.

The light from the secondary fly-eye lens 104 passes through the primary field lens 105, changes it's travel direction toward the right-angle direction by the mirror 106, and finally passes through the secondary field lens 107. The primary field lens 105 and the secondary field lens 107 have the function to overlap the light flux divided by the primary fly-eye lens 102 together on each LCD panel 112R, 112G, and 112B in order to uniform the illumination of the display device.

The light reached to the primary dichroic mirror 108 is separated per wavelength. As a result, red light penetrates through the primary dichroic mirror 108 and travels to the mirror 109. The blue light and the green light are reflected by the primary dichroic mirror 108 and the reflected lights then travel to the secondary dichroic mirror 110. The red light reflected by the mirror 109 travels to the collimator lens 111R. The collimator lens 111R corrects the angle of the red light. The corrected green red light is applied to the LCD panel 111R for red color.

On the other hand, the green light is reflected by the secondary dichroic mirror 110. The collimator lens 111G corrects the angle of the reflected green light. The corrected green light is applied to the LCD panel 112G for green color. The blue light penetrating through the secondary dichroic mirror 110 travels to the collimator lens 111B through the primary relay lens 113, the mirror 114, the secondary relay lens 115, and the mirror 116. The collimator lens 111B corrects the blue light and the corrected blue light is applied to the LCD panel 112B for blue color.

Each of the LCD panels 112R, 112G, and 112B modulates the penetrating light according to each image signal corresponding to each color. The image lights from each of the LCD panels 112R, 112G, and 112B are condensed to a dichroic prism 117.

The dichroic plane 117R of the dichroic prism 117 reflects the red light and penetrates the green light and the blue light.

The dichroic plane 117B thereof reflects the blue light and penetrates the red light and the green light. The dichroic prism 117 synthesizes the image light of each color. The full-color light travels to the projecting lens 118.

Because each of the LCD panels 112R, 112G, and 112B and the screen panel (omitted from drawings) has the conjugate relationship by the projecting lens 118, the image of each of the LCD panels 112R, 112G, and 112B is enlarged and displayed on the screen (omitted from drawings).

By the way, the polarization converting optical system shown in FIG. 1, FIG. 2, and FIG. 3 involves a drawback that the amount of vignette of light caused by the obstructer 103b in the polarizing conversion element 103 is large. This reduces the efficiency for use of light. Therefore in a case of the image display device shown in FIG. 3, the total amount of the light on the screen is not reached to a necessary amount.

Next, a description will now be given of a matter to be solved in efficiency of use of light in the polarization converting optical system.

FIG. 4 is a diagram showing a brilliance distribution of arc discharge in the lamp illuminant 101a used in the conventional lamp 101.

In FIG. 4, reference characters 101d and 101e designate electrodes of the lamp illuminant 101a, respectively. Reference characters Pd and Pe denote front points of luminescence close to the electrodes 101d and 101e, respectively. Reference character Pf indicates the center point between the front points Pd and Pe. Reference character Z designates an optical axis of the lamp 101. The center point Pf and the parabolic focus of the lamp reflector 101b are in agreement. In FIG. 4, the brilliance distribution of the lamp illuminant 101a is shown using counter lines in which relative brilliance is shown in increment 10 of elevation. The brilliance distribution spreads with the length corresponding to the arc length “d” of the arc discharge. Because the front points Pd and Pe have the highest brightness in luminous, the amount of light around the focus area of the lens array 102 cannot be disregarded.

FIG. 5 is a diagram showing light locus emitted from the center point Pf and the front points Pd and Pe and condensed by the lens array 102. In FIG. 5, the same reference numbers and characters of the configuration shown in FIG. 1 and FIG. 4 will be referred to with the same reference numbers and characters.

In FIG. 5, the illuminant image of the lights emitted from the lamp 101 greatly spreads at the area relatively close to the optical axis Z and the illuminant image thereof is gradually reduced in size according to the distance measured from the optical axis Z.

This property means that the power of the lights close to the optical axis Z in the lamp reflector 101b becomes strong and gradually reduced according to the distance measured from the optical axis Z.

For this reason, because the incident aperture and the obstructer 103b of the PBS prism 103a are arranged alternately in the polarizing conversion element 103, when the illuminant image shown in FIG. 5 is input into the polarizing conversion element 103 without adjustment processing, the efficiency for use of light is reduced because the amount of vignette of lights caused by the obstructer 103b is increased at the area close to the optical axis Z. The inventors of the present invention solved this conventional drawback described above.

FIG. 6A and FIG. 6B are diagrams showing the features of both the conventional lamp and the lamp invented by the inventors of the present invention

The feature of the lamp invented by the inventors of the present invention is that a lamp reflector 101b and a lamp front glass 101c are formed with an aspherical-shaped configuration so that a same power is applied to all of lights emitted from the lamp illuminant 101a.

FIG. 6A shows the lamp 101 having the conventional lamp reflector 101b having the configuration of the shape of a paraboloid of revolution where the density of lights close to the optical axis Z of the lamp 101 is high and the density of the lights apart from the optical axis Z becomes gradually low. This means that the power of the lamp reflector 101b is gradually reduced from the optical axis Z toward the outside of the optical axis Z.

On the other hand, FIG. 6B shows the configuration of the lamp 201 invented by the inventors of the present invention, where the density of lights emitted from the lamp front aspherical lens 201c becomes uniform regardless of the distance measured from the optical axis Z.

This means that the same power is applied to each light in the optical system having the configuration of the aspherical-shaped lamp reflector 201b and the aspherical-shaped lamp front aspherical lens 201c.

FIG. 7 is a diagram showing the spreading of the illuminant image of the lamp invented by the inventors of the present invention. In FIG. 7, the same components of the configuration shown in FIG. 6A and FIG. 6B will be referred to with the same reference numbers and characters.

As shown in FIG. 7, in the lamp 201 the size of the illuminant image becomes constant regardless of the distance measured from the optical axis Z. When the lamp 201 is applied to the polarizing conversion element 103, it is possible to reduce the amount of vignette of lights caused by the obstructer 103b. This feature can be effectively applied to the fly-eye lens 102A shown in FIG. 8 in which a plurality of lenses are arranged in a circle shape.

Because the conventional lamp has the configuration described above, when the conventional lamp is applied to the angular-type fly-eye lens, the amount of the leaking loss of lights becomes large. This causes the drawback to reduce the efficiency for use of light.

That is, when the lamp 201 is applied to the angular-type fly-eye lens 102B so that the device is reduced in size as shown in FIG. 9, the amount “L” of the light leaking through the space formed between the aperture of the lamp 210 and the angular-type fly-eye lens 102B becomes increased. As can be understood from FIG. 6B, because the sectional area of the lights reflected by the aspherical-shaped lamp reflector 201b is spread, the area where the amount of light is low has a larger amount of the leaking when compared with the area close to the optical axis Z where the density of the lights becomes high. In an actual lamp the leaking loss of lights described above becomes greater than the leaking loss caused in the polarizing conversion. This reduces the efficiency for use of light.

### SUMMARY OF THE INVENTION

The present invention has been made to solve the above conventional drawbacks of the lamp.

It is therefore an object of the present invention to provide a high efficiency lamp, when compared with conventional lamp, capable of reducing the leaking loss of light when the lamp is applied to an angular-type fly-eye lens.

Another object of the present invention is to provide a polarization converting optical system having an improved efficiency for use of light, and to provide an image display system capable of increasing the amount of light on a screen.

According to the present invention, a lamp has a lamp illuminant, a lamp reflector, and a lamp front glass. The lamp illuminant emits lights from an arc discharge therein. The lamp reflector of a shape of revolution is placed on an optical axis of the lamp illuminant, formed around the optical axis for reflecting the lights from the lamp illuminant. The lamp front glass penetrates the lights reflected by the lamp reflector. In the lamp, at least a part of the lamp reflector, within a range from the optical axis to a design boundary of a predetermined distance from the optical axis, is formed with a shape of an aspherical of revolution for reflecting a light flux while spreading a sectional area of the light flux, and at least a part of the lamp reflector outside from the design boundary is formed with a shape of a paraboloid of revolution for reflecting a light flux in parallel to the optical axis. The lamp front glass outputs, in parallel to the optical axis, the light flux reflected by the lamp reflector with the shape of the aspherical of revolution and the shape of the paraboloid of revolution.

In another aspect of the present invention, a polarization converting optical system has the lamp of the present invention, an angular-type lens array, and a polarizing conversion element. The angular-type lens array has a plurality of lenses arranged in an angular-shaped array, condenses lights from the lamp on the focuses of a plurality of lenses. The polarizing conversion element has a plurality of polarizing beam splitters arranged in array, placed in an area close to the focuses of a plurality of the lenses, matches two polarized components of the lights from the angular-type lens array, which are intersected at right angles.

In another aspect of the present invention, an image display system has the lamp or the polarization converting optical system according to the present invention, at least not less than one LCD panel, an illumination optical system, a screen, and a projecting optical system. At least not less than one LCD panel modulates lights according to an image signal. The illumination optical system receives the lights from the lamp 1 and irradiates the lights onto the LCD panel. The screen receives the lights modulated by the LCD panel and displays the image thereon. The projecting optical system projects the lights modulated by the LCD panel onto the screen.

### BRIEF DESCRIPTION OF THE DRAWINGS

Other objects, features and advantages of the present invention will become apparent from the following description taken in conjunction with the accompanying drawings, in which:

FIG. 1 is a diagram showing a configuration of the conventional polarization converting optical system;

FIG. 2 is a diagram explaining the operation of the polarizing conversion element;

FIG. 3 is a diagram showing a configuration of a typical optical system of a conventional image display system using LCD;

FIG. 4 is a diagram showing a brilliance distribution of the lamp illuminant of the lamp;

FIG. 5 is a diagram showing a trace of paths of lights emitted from the center point and both ends of the area of arc discharge and then condensed by the lens array;

FIG. 6A and FIG. 6B are diagram to briefly compare the features of the conventional lamp and the lamp invented by the inventors of the present invention;

FIG. 7 is a diagram showing a spread of the illuminant image of the lamp invented by the inventors of the present invention;

FIG. 8 is a diagram showing a case to apply the lamp invented by the inventors of the present invention to a fly-eye lens;

FIG. 9 is a diagram showing a case to apply the lamp to an angular-type fly-eye lens;

FIG. 10A and FIG. 10B are diagrams showing a configuration of a lamp of a first embodiment of the present invention;

FIG. 11 is a diagram showing a spreading of the illuminant image of the lamp of the first embodiment of the present invention; and

FIG. 12 is a diagram showing an optical system of an image display system of a second embodiment of the present invention.

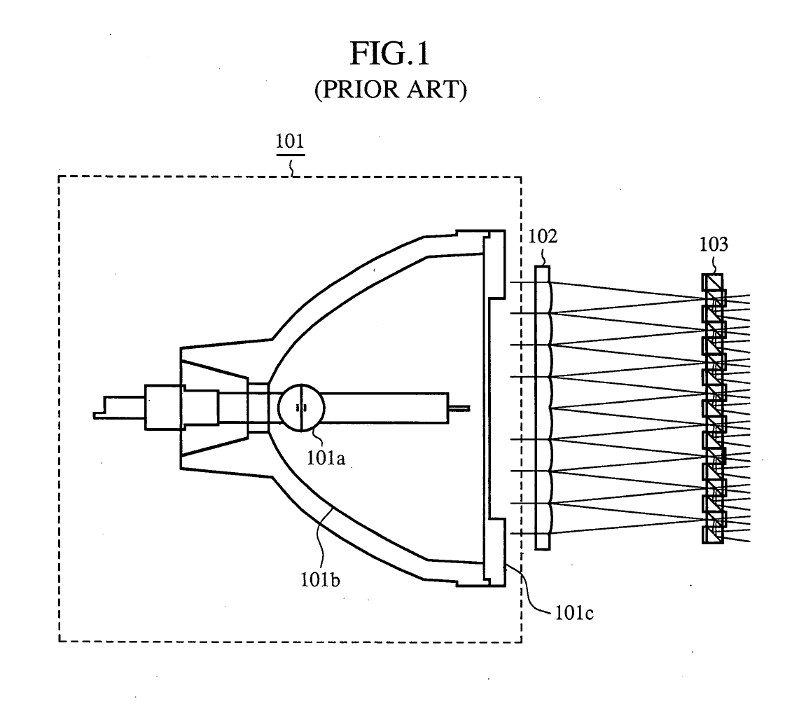

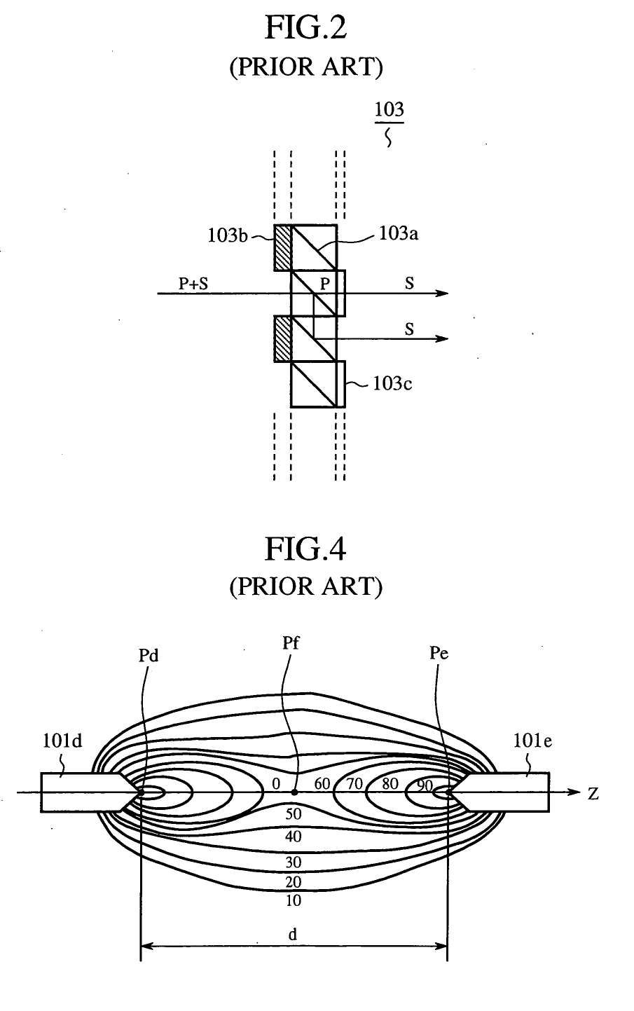

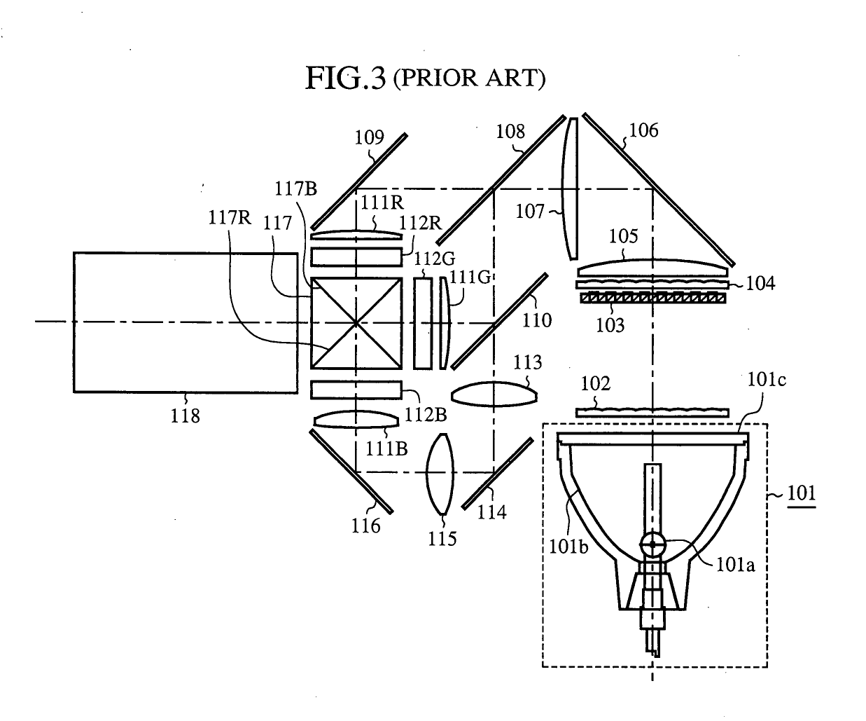

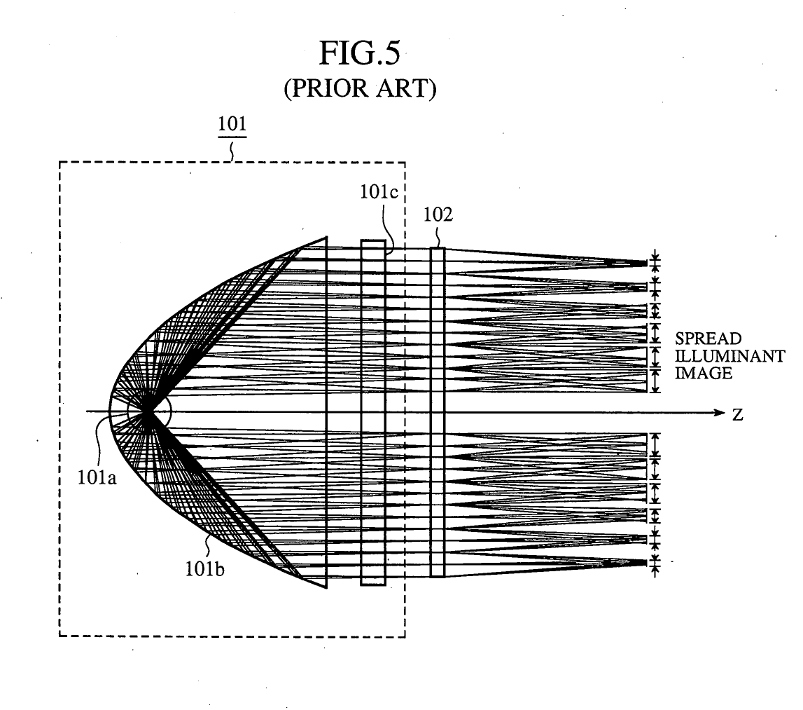

### DETAILED DESCRIPTION OF THE PREFERRED EMBODIMENTS

A detailed description will be given, with reference to the accompanying drawings, of the preferred embodiments of the present invention.

First Embodiment

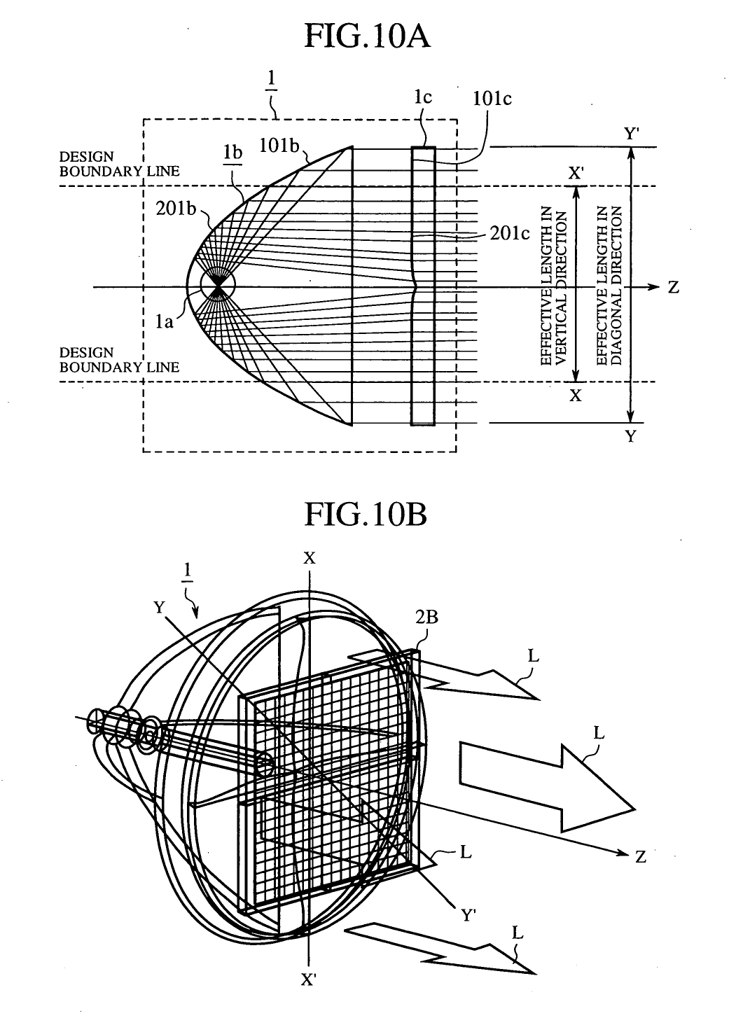

FIG. 10A and FIG. 10B are diagrams showing a configuration of a lamp of a first embodiment according to the present invention. In FIG. 10A and FIG. 10B, reference number 1 designates a lamp of the first embodiment, reference character 1a denotes a lamp illuminant to emit lights by arc discharge and 1b indicates a hybrid lamp reflector to reflect the light from the lamp illuminant 1a in forward direction. Reference character 1c designates a hybrid lamp front lens mounted at the aperture of the hybrid lamp reflector 1b to collimate the lights emitted from the center of the arc discharge of the lamp illuminant la and then reflected by the hybrid lamp reflector 1b in parallel light. Reference character Z designates an optical axis of the lamp 1, and 2B denotes an angular-type fly-eye lens.

The lamp 1 of the first embodiment comprises the lamp illuminant 1a, the hybrid lamp reflector 1b, and the hybrid lamp front lens 1c. This angular-type fly-eye lens 2B has a difference vertical line and a diagonal line. The effective length X-X′ of the vertical line and the effective length Y-Y′ of the effective diagonal line are different to each other (see FIG. 10B).

The lamp 1 of the first embodiment has a different design concept for the light fluxes emitted from the center of the arc discharge of the lamp illuminant 1a reflected by the hybrid lamp reflector 1b in two areas when the nearest light to the optical axis Z is set as a design boundary line:

The first area (having a diameter within the effective length X-X′ in vertical direction) from the optical axis Z to the design boundary line; and

The second area (having a diameter within the effective length Y-Y′ in diagonal direction of the optical axis Z to the design boundary line, which is greater than the effective length X-X′ in vertical direction) which is outside of the design boundary line.

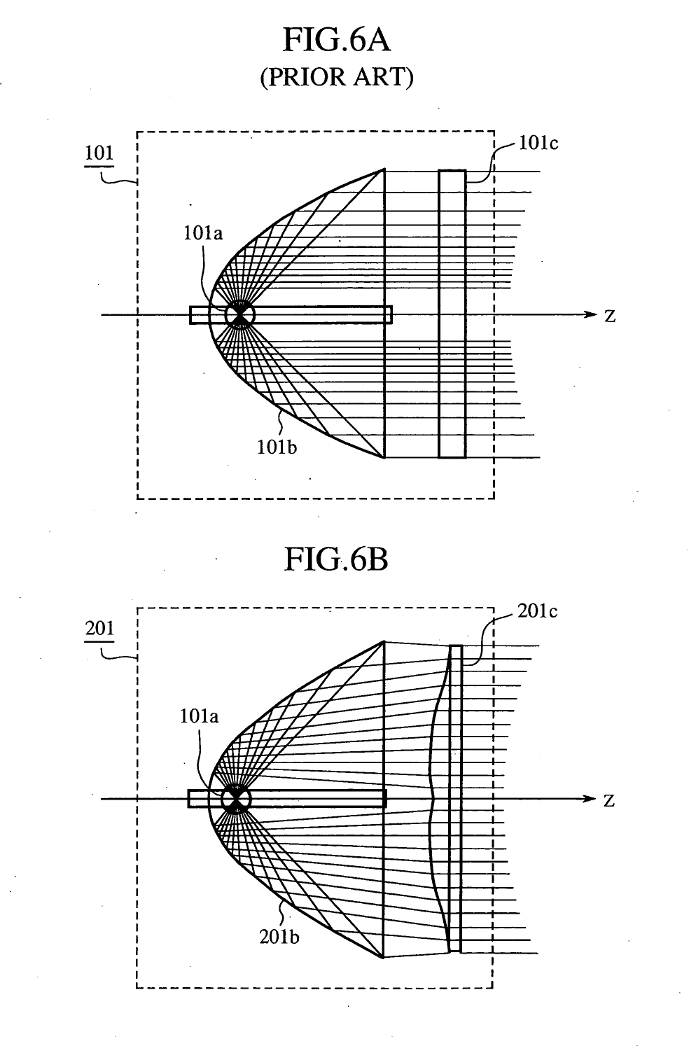

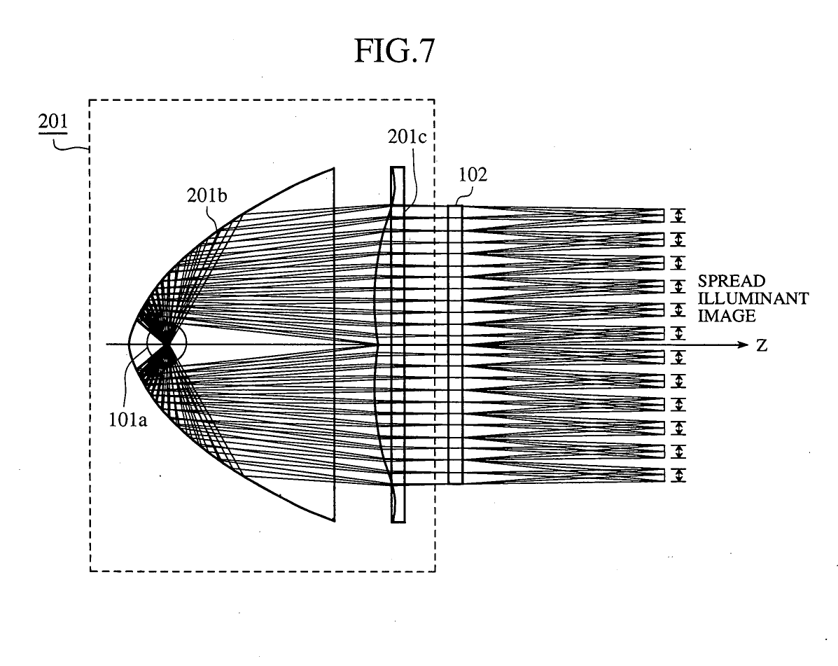

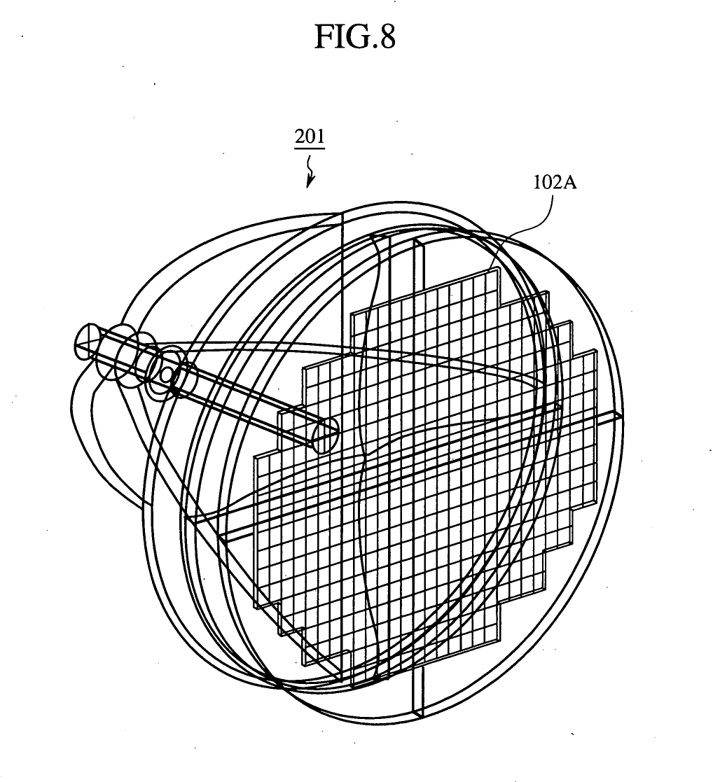

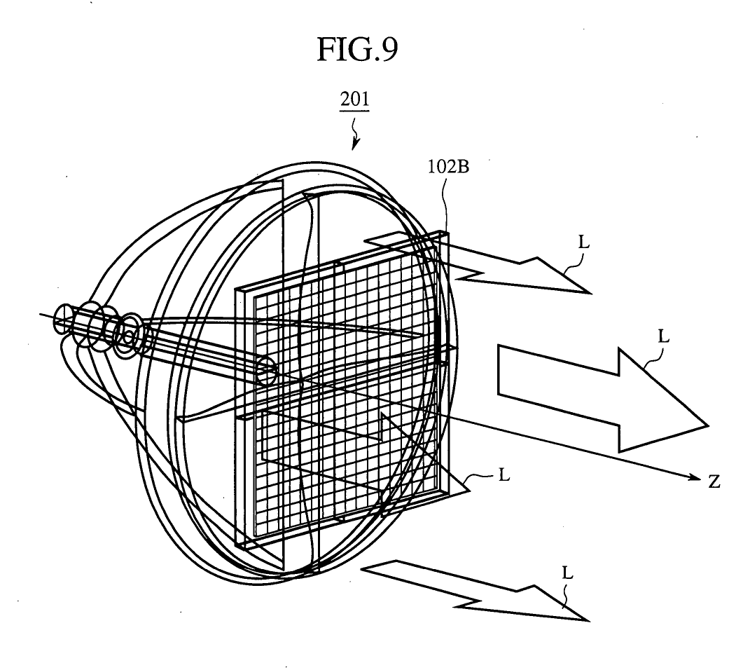

That is, as shown in FIG. 10A, in the first area having the diameter within the effective length X-X′ in vertical direction, like the case shown in FIG. 6B, the hybrid lamp reflector 1b is formed as the lamp reflector 201b (see FIG. 6B) of aspherical of revolution which reflects the sectional area of the light flux emitted from the center of the arc discharge so that the light flux is spread.

Like the same manner, the hybrid lamp front lens 1c in the first area is formed as the lamp front aspherical lens 201c (see FIG. 6B) which collimates the light flux reflected by the lamp reflector 201b in parallel to the optical axis Z.

By this configuration of the lamp 1 of the first embodiment, each light flux traveling through the first area has a same power in order to reduce the illuminant image obtained by the collecting function of the angular-type fly-eye lens 2B.

On the other hand, in the second area which is outside of the effective length X-X′ in vertical direction, the hybrid lamp reflector 1b of the lamp 1 of the first embodiment has the same configuration of the conventional lamp reflector 101b of the paraboloid of revolution and the hybrid lamp front lens 1c has also the same configuration of the lamp front glass 101c (see FIG. 6A) of the conventional one.

In the second area, the lamp reflector 101b of the paraboloid of revolution therefore reflects the light flux emitted from the center of the arc discharge of the lamp illuminant 1a in parallel to the optical axis Z and the hybrid lamp front lens 1c does not reflect most of the light flux in the second area.

Thus, the feature of the lamp 1 of the first embodiment is to have the hybrid lamp reflector 1b formed by the combination of the paraboloid of revolution of the conventional lamp reflector 101b and the aspherical-shaped lamp reflector 201 invented by the inventors of the present invention.

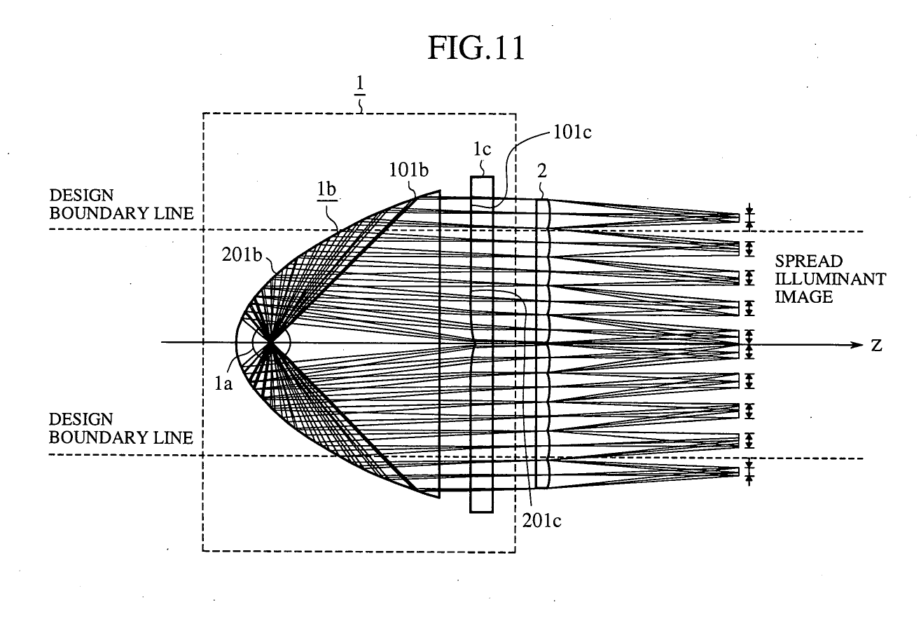

This hybrid design of the lamp 1 of the first embodiment is capable both of eliminating the leaking loss in the direction toward the outside from the optical axis Z and of obtaining the illuminant image reduction effect at the focus of the angular-type fly-eye lens 2B shown in FIG. 10B. This can reduce the leaking amount “L” of the lights shown in FIG. 10B and also increase the efficiency to condense the lights into the polarizing conversion element (omitted from the drawings). FIG. 11 is a diagram showing the spreading of an illuminant image of the lamp of the first embodiment according to the first embodiment.

As can be understood from FIG. 11, in the first area from the optical axis Z to the design boundary line, the illuminant image has a same magnitude by the function of both the aspherical-shaped lamp reflector 201b and the lamp front aspherical lens 201c.

On the other hand, in the second area outside from the design boundary line it can be understood that the magnitude of the illuminant image is reduced by the function of both the lamp reflector 101b of the paraboloid of revolution and the lamp front glass 101c.

The case of the first embodiment described above uses the design boundary line which is set on the effective length X-X′ in vertical direction of the angular-type fly-eye lens 2B for brief explanation. The lamp 1 of the first embodiment to uniform the power only using the first area tends to spread the illuminant image, when compared with the lamp invented by the inventers described in the “Description of the Related Art” section, which uniforms the power using the entire of the effective area of the lamp.

In order to obtain the optimum actual design, the distance to the design boundary line is set after considering that the sum of the leaking loss of the spreading of lights and the leaking loss of the spreading of the illuminant image becomes the minimum value.

As described above, according to the first embodiment, the lamp 1 of the first embodiment has the hybrid lamp reflector 1b and the lamp front lens 1c. The hybrid lamp reflector 1b has the lamp reflector 101b of the paraboloid of revolution and the lamp reflector 201b of aspherical of revolution. The lamp reflector 101b of the paraboloid of revolution is formed in the area which is outside of the design boundary line. The lamp reflector 201b of aspherical of revolution is formed in the second area between the design boundary line and the optical axis Z.

The hybrid lamp front lens 1c reflects the lights emitted from the center of the arc discharge of the lamp illuminant 1a and reflected at the hybrid lamp reflector 1b in parallel to the optical axis Z. It is possible to reduce the amount L of the leaking of light when the lamp 1 is applied to the angular-type fly-eye lens 2B and thereby to improve the efficiency for use of light.

By the way, the easy design for the hybrid lamp reflector 1b and the hybrid lamp front lens 1c can be achieved using a paraboloid-shaped part and an aspherical-shaped part which are divided by the design boundary line. It is possible to have another configuration of the lamp in which the reflecting surface of the lamp reflector is so formed that the aspherical-shaped part and the paraboloid-shaped part are gradually changed around the design boundary line. This configuration can achieve a smoothly reflecting characteristic of light in the area close to the design boundary line and to increase the optical performance.

Further, it is also possible to eliminate at least a part (which reflects lights of the leaking amount L) of the area in the hybrid lamp reflector 1b outside of the design boundary line. This configuration can reduce the entire size of the lamp without changing any amount of light input from the lamp 1 to the angular-type fly-eye lens 2B. This configuration, of course, does not introduce any serious problem.

Second Embodiment

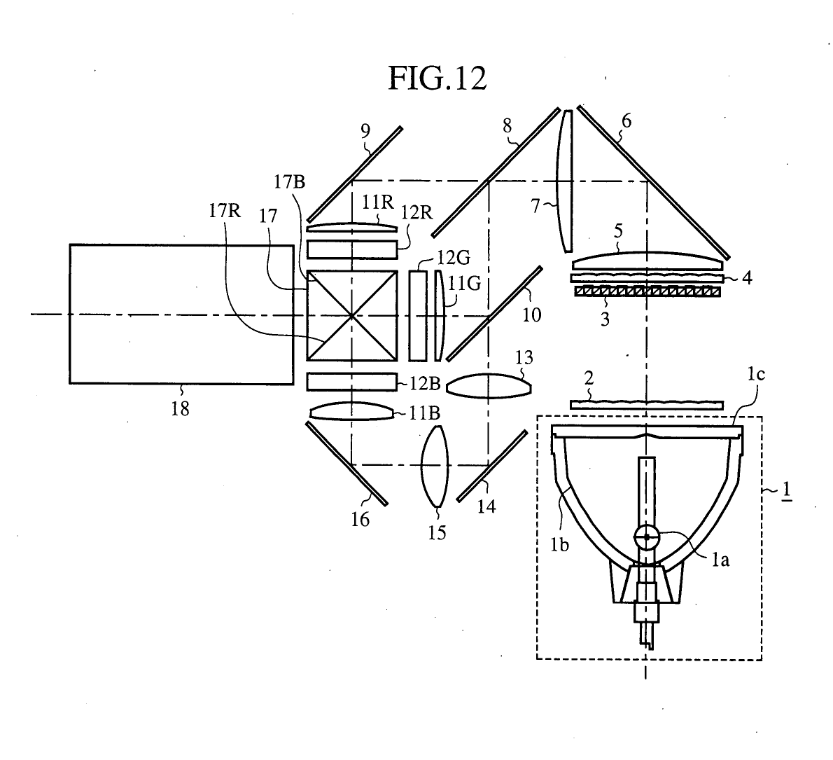

FIG. 12 is a diagram showing a configuration of an optical system in an image optical system of a second embodiment according to the present invention. The same components of the configuration shown in FIG. 10A, FIG. 10B, and FIG. 11 will be referred to with the same reference numbers and characters.

In FIG. 12, reference number 2 designates a primary fly-eye lens (lens array), 3 denotes a polarizing conversion element, 4 indicates a secondary fly-eye lens (illumination optical system), 5 designates a primary field lens (illumination optical system), 6 denotes a mirror (illumination optical system), 7 indicates a secondary field lens (illumination optical system), 8 denotes a primary dichroic mirror (illumination optical system), 9 indicates a mirror (illumination optical system), and 10 designates a secondary dichroic mirror (illumination optical system). Each of reference characters 11R, 11G, and 11B designates a collimator lens (illumination optical system), and each of reference characters 12R, 12G, and 12B denotes a LCD panel for red, green, and blue color, respectively. Reference number 13 designates a primary relay lens (illumination optical system), 14 denotes a mirror (illumination optical system), 15 indicates a secondary relay lens (illumination optical system), 16 indicates a mirror (illumination optical system), 17 designates a dichroic prism, and 18, denotes a projecting lens (projecting optical system).

Next, a description will now be given of the operation of the image display device according to the second embodiment.

The lights emitted from the lamp illuminant 1a are reflected by the hybrid lamp reflector 1b shown in the description of the first embodiment in order to form a parallel light flux. The parallel light flux is reflected by the hybrid lamp reflector 1b shown in the first embodiment and then becomes a parallel light flux. The parallel light flux is output to the front section of the lamp 1 through the hybrid lamp front glass 1c.

The parallel light flux from the lamp 1 (as a polarization converting optical system) is input into the primary fly-eye lens 2 (as the polarization converting optical system) and divided into a plurality of light fluxes. Each light flux divided is focused on the polarizing conversion element 3 (as the polarization converting optical system). The polarized lights passing through the polarizing conversion element 3 are aligned and pass the secondary fly-eye lens 4 placed immediately following the polarizing conversion element 3.

The secondary fly-eye lens 4 has the function to set the surface of the primary fly-eye lens 2 and each surface of the LCD panels 12R, 12G, and 12B for each color into a conjugate relationship.

The lights from the secondary fly-eye lens 4 pass through the primary field lens 5, and then are changed its traveling direction in vertical direction by the mirror 6. The lights changed in its traveling direction pass through the secondary field lens 7.

The secondary field lens 7 is capable of overlapping the light fluxes divided by the primary fly-eye lens 2 on each of the LCD panels 12R, 12G, and 12B. It is thereby possible to uniform the illumination on the display device.

The lights which have been reached the primary dichroic mirror 8 are separated in wavelength. The red light travels to the mirror 9 trough the mirror 8 and the blue light and the green light are reflected by the mirror 8 and the reflected lights then travel to the secondary dichroic mirror 10. The red light reflected by the mirror 9 is compensated in its light angle and supplied to the CD panel 11R for red color. On the other hand, the green light is reflected by the secondary dichroic mirror 10, and its light angle thereof is corrected by the collimator lens 11G. The green light corrected is supplied to the LCD panel 12G for green color.

The blue light passes through the secondary dichroic mirror 10 and reached to the collimator lens 11B through the primary relay lens 13, the mirror 14, the secondary relay lens 15, and the mirror 16. The blue light is corrected in its light angle and supplied to the LCD panel 12B for blue color.

The light passing through each of the LCD panels 12R, 12G, and 12B is modulated according to the image signal for each color and collected into the dichroic prism 17. The red light is reflected by the dichroic plane 17R in the dichroic prism 17 and the green light and the blue light pass through the dichroic plane 17R.

The blue light is reflected by the dichroic plane 17B in the dichroic prism 17 and the green light and the red light pass through the dichroic plane 17B. The function of the dichroic prism 17 described above synthesizes each color image to generate the synthesized lights as a full-color image. The synthesized one is supplied to the projecting lens 18.

Because each of the LCD panels 12R, 12G, and 12B and the surface of the screen (omitted from the drawings) have the conjugate relationship by the projecting lens 18, the image on each of the LCD panels 12R, 12G, and 12B is enlarged and displayed on the screen (omitted from the drawings).

The polarization converting optical system and the image display system use the conventional lamp 101 instead of the lamp 1 of the first embodiment.

The lamp 1 of the first embodiment is effective in use when the primary fly-eye lens 2 has the configuration of the angular-type fly-eye lens 2B shown in FIG. 10B. This configuration makes it possible to reduce the amount of vignette of lights at the polarizing conversion element 2 and thereby to improve the light transparent efficiency and to increase the amount of lights reached to the screen.

The image display system shown in FIG. 12 is not limited by this configuration described above. For example, it is acceptable for the polarization converting optical system to have at least one or more LCD panels, the projecting lens, and the screen. It is also possible to irradiate the lights emitted from the lamp 1 without polarization conversion to the LCD panel through the illumination optical system. In addition, the configuration of the illumination optical system is not limited by the case shown in FIG. 12, and it is possible to change the configuration according to various demands.

As described above, according to the second embodiment, the lamp 1 has the primary fly-eye lens 2B of an angular type having a plurality of lenses arranged in angular-shape to condense the lights into each focus of a plurality of the lenses, the polarizing conversion element 3 having a plurality of polarizing beam splitters arranged in array and placed at the area close to the focuses of a plurality of the lenses so as to match P and S polarized components together, which are intersected at right angles, of the lights from the primary fly-eye lens 2B through a plurality of the polarizing beam splitters. It is thereby possible to improve the efficiency of use of lights in the polarization converting optical system.

In addition, according to the second embodiment, the image display device has the lamp 1 or the polarizing conversion system, the liquid crystal panel of at least one or more, the screen, and the projecting lens. The polarizing conversion system uses the primary fly-eye lens 2B of an angular-type and the polarizing conversion element 3. The LCD panel receives the light from this polarization converting optical system or the lamp. 1 through the illumination optical system, and modulates the received one according to the image signals. The projecting lens projects the light modulated by the liquid crystal panel to the screen. It is possible to increase the amount of lights reached to the screen.

As set forth in detail, according to the present invention, at least a part of the lamp reflector is formed within a range from the optical axis to a design boundary of a predetermined distance from the optical axis, and with a shape of an aspherical of revolution for reflecting a light flux while spreading a sectional area of the light flux. At least a part of the lamp reflector outside from the design boundary is formed with a shape of a paraboloid of revolution for reflecting a light flux in parallel to the optical axis. The lamp front glass outputs, in parallel to the optical axis, the light flux reflected by the lamp reflector with the shape of the aspherical of revolution and the shape of the paraboloid of revolution. There is the effect that it is possible to reduce the amount of leaking of light when the lamp is applied to an angular-type fly-eye lens and thereby to improve the efficiency for use of light.

In the lamp of the present invention, the lamp reflector has the shape of the aspherical of revolution and the shape of the paraboloid of revolution which are gradually changed around the design boundary toward the outside direction from the optical axis. There is the effect that it is possible to obtain a smooth reflection characteristic of light at the area near to the design boundary.

In the lamp of the present invention, the lamp reflector has two parts, one part from the optical axis to the design boundary is formed with the shape of the aspherical of revolution. The other part outside from the design boundary is formed with the shape of the paraboloid of revolution. There is the effect that it is possible to design the lamp easily.

In the lamp of the present invention, at least a part of the lamp reflector outside of the design boundary is cut. There is the effect that it is possible to form the lamp with a simple size.

According to the present invention, a polarization converting optical system has the lamp of the present invention, an angular-type lens array, and a polarizing conversion element. The angular-type lens array has a plurality of lenses arranged in an angular-shaped array, condenses lights from the lamp on the focuses of a plurality of lenses. The polarizing conversion element has a plurality of polarizing beam splitters arranged in array, placed in an area close to the focuses of a plurality of the lenses, matches two polarized components of the lights from the angular-type lens array, which are intersected at right angles. There is the effect that it is possible to provide the polarization converting optical system with an improved efficiency for use of light.

According to the present invention, an image display system has the lamp or the polarization converting optical system of the present invention, at least not less than one LCD panel, an illumination optical system, a screen, and a projecting optical system. The LCD panels modulate lights according to an image signal. The illumination optical system receives the lights from the lamp 1 and irradiates the lights onto the LCD panel. The screen receives the lights modulated by the LCD panel and for displaying the image thereon. The projecting optical system projects the lights modulated by the LCD panel onto the screen. There is the effect that it is possible to provide the image display system capable of increasing the amount of lights on the screen.

While the above provides a full and complete disclosure of the preferred embodiments of the present invention, various modifications, alternate constructions and equivalents may be employed without departing from the scope of the invention. Therefore the above description and illustration should not be construed as limiting the scope of the invention, which is defined by the appended claims.

1. A lamp comprising:
a lamp emitting light from an arc discharge within the lamp;
a lamp reflector having a surface of revolution, placed on an optical axis of the lamp, located around the optical axis for reflecting the light emitted from the lamp; and
a lamp front glass for penetration by the light reflected by the lamp reflector, wherein
at least a part of the lamp reflector, within a range from the optical axis to a boundary at a predetermined distance from the optical axis, has a surface of aspherical revolution for reflecting a light flux while spreading a sectional area of the light flux,
at least a part of the lamp reflector beyond the boundary has a surface of a paraboloid of revolution for reflecting a light flux parallel to the optical axis, and
the lamp front glass outputs, parallel to the optical axis, the light flux reflected by the lamp reflector having the surface of the aspherical revolution and the surface of the paraboloid of revolution.

2. The lamp according to claim 1, wherein the lamp reflector has the surface of the aspherical revolution and the shape of the paraboloid of revolution, which gradually change around the boundary, in a direction outward from the optical axis.

3. The lamp according to claim 1, wherein the lamp reflector has two parts, one part from the optical axis to the boundary having the surface of the aspherical revolution, and the other part, beyond from the boundary, having the surface of the paraboloid revolution.

4. The lamp according to claim 1, wherein at least a part of the lamp reflector outside of the design boundary is cut.

5. A polarization converting optical system comprising:
the lamp according to claim 1;
an angular lens array having a plurality of lenses arranged in an angular-shaped array, for condensing light from the lamp on foci of a plurality of lenses; and
a polarizing conversion element having a plurality of polarizing beam splitters arranged in an array, and located close to the foci of the plurality of the lenses, for matching two polarized components of the light from the angular lens array, which intersect at right angles.

6. An image display system comprising:
the lamp according to claim 1;
at least one LCD panel for modulating the light according to an image signal;
an illumination optical system for receiving the light from the lamp and for irradiating the LCD panel with the light;
a screen for receiving the light modulated by the LCD panel and for displaying an image derived from the image signal; and
a projecting optical system for projecting the light modulated by the LCD panel onto the screen.

7. An image display system comprising:
the polarization converting optical system according to claim 5;
at least one LCD panel for modulating light according to an image signal;
an illumination optical system for receiving the light from the polarization converting optical system and for irradiating the LCD panel with the light;
a screen for receiving the light modulated by the LCD panel and for displaying an image derived from the image signal; and
a projecting optical system for projecting the light modulated by the LCD panel onto the screen.
